(19) United States
(12) Patent Application Publication
(10) Pub. No.: US 2006/0095624 A1
(43) Pub. Date: May 4, 2006

(54) Retargeting device interrupt destinations

(76) Inventors: Ashok Raj, Portland, OR (US); Rajesh Shah, Portland, OR (US)

Correspondence Address: KONRAD RAYNES & VICTOR, LLP, 315 S. BEVERLY DRIVE, # 210, BEVERLY HILLS, CA, 90212, US

(21) Appl. No.: 10/981,091

(22) Filed: Nov. 3, 2004

(51) Int. Cl. G06F 13/24

(52) U.S. Cl. 710/260

(57) ABSTRACT

Provided are a method, system, and article of manufacture, where a determination is made of one of a plurality of processors to disable, where the plurality of processors are processing interrupts from at least one device. An interrupt directed at the determined processor is communicated to at least one other processor of the plurality of processors while receiving the interrupts from the at least one device. The determined processor is disabled.

### BACKGROUND

Certain computing systems provide the ability to disable or physically replace a processor without powering off or rebooting the system. For example, in certain systems a processor may be disabled or removed in response to a fault that triggers the removal of the processor. Additionally, in certain other systems a processor may be added or removed to change system capacity or to support domain partitioning.

In an operational computing system, one or more active Input/Output (I/O) devices may actively generate interrupts directed to the processors in the computing system. A computing system can malfunction if an I/O device attempts to send an interrupt to a processor that is being removed. The malfunctioning may be prevented by stopping and restarting, or suspending and resuming the operations of I/O devices when a processor is being removed. Stopping and restarting, or suspending and resuming the operations of an I/O device may decrease the performance of the computing system by consuming processing time. In certain cases, stopping and restarting, or suspending and resuming the operations of an I/O device may cause the computing system to be rebooted.

Furthermore, stopping and restarting, or suspending and resuming an I/O device may require software support from the corresponding I/O device driver stack. The software support may have to be provided by the vendor of the I/O device and may have to be replicated for each I/O device. If there are any defects or deficiencies in the I/O device driver stack, the stopping and restarting, or suspending and resuming routines may fail.

### BRIEF DESCRIPTION OF THE DRAWINGS

Referring now to the drawings in which like reference numbers represent corresponding parts throughout:

FIG. 1 illustrates a computing environment, in accordance with certain embodiments;

FIG. 2 illustrates additional elements and data structures of the computing environment of FIG. 1, in accordance with certain embodiments;

FIG. 3 illustrates how an exemplary processor may be disabled in the computing environment of FIG. 1, in accordance with certain embodiments;

FIG. 4 illustrates operations for disabling a processor while continuing to receive interrupts from devices, in accordance with certain embodiments;

FIG. 5 illustrates operations for communicating an interrupt directed at a processor to another processor, in accordance with certain embodiments;

FIG. 6 illustrates operations for mapping interrupt destinations for interrupts;

FIG. 7 illustrates operations for processing interrupts in a local interrupt controller of a processor, in accordance with certain embodiments;

FIG. 8 illustrates operations for processing interrupts that are received from a device during a mapping of the interrupt destinations, in accordance with certain embodiments;

FIG. 9 illustrates a block diagram of a first system corresponding to certain elements of the computing environment of FIG. 1, in accordance with certain embodiments; and

FIG. 10 illustrates a block diagram of a second system including certain elements of the computing environment of FIG. 1, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

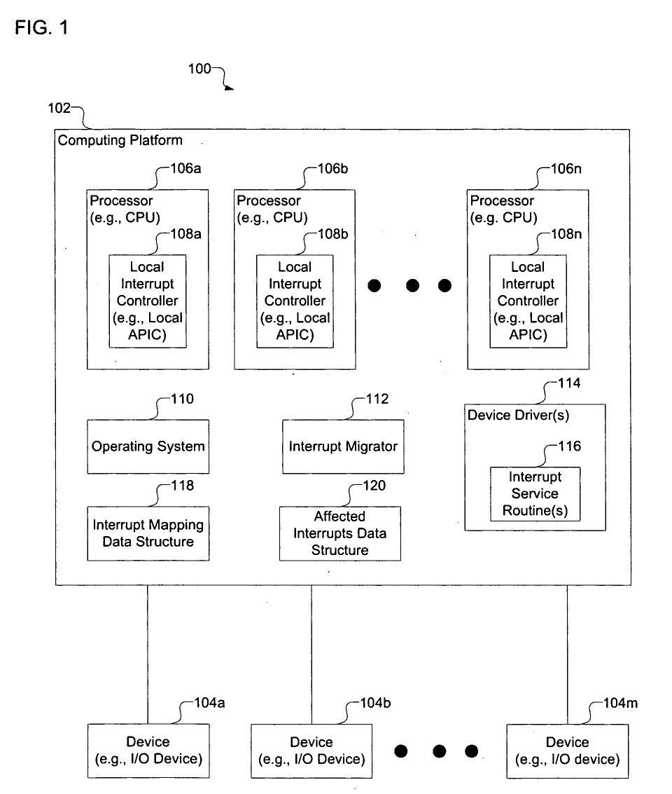

FIG. 1 illustrates a computing environment 100, in accordance with certain embodiments. The computing environment 100, comprises a computing platform 102 coupled to a plurality of devices 104a, 104b, . . . , 104m.

The computing platform 102 may comprise a computational device, such as, a personal computer, a workstation, a server, a mainframe, a hand held computer, a palm top computer, a laptop computer, a telephony device, a network computer, a blade computer, etc. The computing platform 102 comprises a plurality of processors 106a, 106b, . . . , 106n that include a plurality of local interrupt controllers 108a, 108b, . . . 108n. For example, in certain embodiments, the processor 106a may include the local interrupt controller 108a, the processor 106b may include the local interrupt controller 108b, and the processor 106n may include the local interrupt controller 108n. In certain embodiments, the processors 106a . . . 106n may be central processing units (CPU), and the local interrupt controllers 108a . . . 108n may be Advanced Programmable Interrupt Controllers (APIC). A local interrupt controller, such as, local interrupt controllers 108a . . . 108n, may store interrupts that are to be processed by the corresponding processor that includes the local interrupt controller. For example, the local interrupt controller 108a may store interrupts that are to be processed by the processor 106a. The interrupts may be generated by the plurality of devices 104a . . . 104m, where the devices 104a . . . 104m may be I/O devices or other devices that generate interrupts.

In addition to the processors 106a . . . 106n and the local interrupt controllers 108a . . . 108n, the computing platform 102 may also comprise an operating system 110, an interrupt migrator 112, one or more device drivers 114 that include one or more interrupt service routines 116, an interrupt mapping data structure 118, and an affected interrupts data structure 120.

The operating system 110 may include system programs that allow applications, such as, the interrupt migrator 112 and the device driver 114 to execute in the computing platform 102. The interrupt migrator 112 is an application that may be implemented in hardware, software, firmware or any combination thereof. The interrupt migrator 112 allows interrupts directed towards one processor to be retargeted towards another processor. For example, in certain embodiments if processor 106a is disabled then the interrupt migrator 112 may retarget an interrupt that is supposed to be processed by processor 106a to be processed by processor 106b instead. In certain embodiments, the devices 104a . . . 104m do not have to be disabled or suspended when one of the plurality of processors 106a . . . 106n is disabled.

The device drivers 114 correspond to the devices 104a . . . 104m. For example, each device, such as, device 104a, may have a corresponding device driver that interfaces the device to the operating system 110. The interrupt service routines 116 implemented in the device drivers 114 may process interrupts received from the devices 104a . . . 104m.

The interrupt mapping data structure 118 includes mappings of interrupts to processors. For example, an entry in the interrupt mapping data structure 118 may map a first interrupt to be processed by the processor 106a, and a second interrupt to be processed by the processor 106c.

In certain embodiments, while the interrupt migrator 112 is retargeting interrupts directed towards a first processor to a second processor, additional interrupts intended for the first processor may be received at the computing platform 102. If the first processor needs to be disabled, the affected interrupts data structure 120 stores these additional interrupts, such that, these additional interrupts are not processed by the first processor that is to be disabled. Additionally, the affected interrupts data structure 120 may also include indications for interrupts that are already in the local interrupt controller of a processor that is to be disabled.

FIG. 1 describes certain embodiments, in which the interrupt migrator 112 retargets an interrupt that is supposed to be processed by a first processor to a second processor, where the first processor needs to be disabled or removed. Interrupts that exist in the local interrupt controller of the processor that needs to be disabled are processed before disabling the processor. Additionally, an indication of the interrupts that arrive for a processor that is to be disabled is stored in the affected interrupts data structure 120, and such interrupts are processed by a processor that is not to be disabled. In certain embodiments, none of the devices 104a . . . 104m have to be stopped or suspended, including no stoppage or suspension of the devices 104a . . . 104m during the time period in which interrupts are being retargeted from one processor to another.

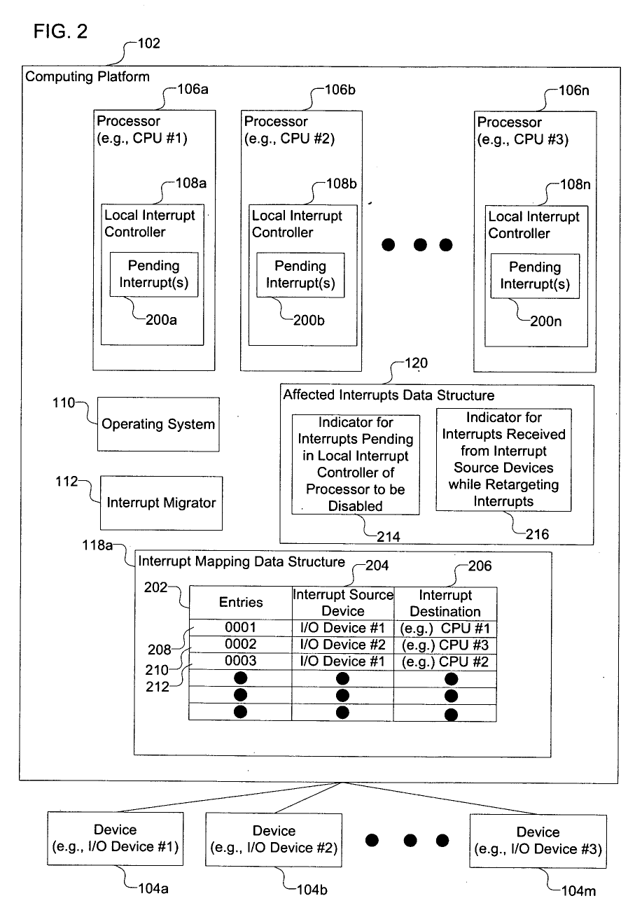

FIG. 2 illustrates additional elements and data structures of the computing environment 100. During the time the operating system 110 or the interrupt migrator 112 determines that a processor, such as, any of the processors 106a . . . 106n, needs to be disabled, some of the processors 106a . . . 106n may include one or more pending interrupts 200a, 200b, . . . , 200n in the local interrupt controllers 108a . . . 108n corresponding to the processors 106a . . . 106n. It is possible that certain processors do not include any pending interrupts. The pending interrupts in a processor should be processed before the processor is disabled. For example, if processor 106a is to be disabled, then in certain embodiments the one or more pending interrupts 200a are processed by the processor 106a before the processor 106a is disabled.

The interrupt mapping data structure 118a, that is an exemplary embodiment of the interrupt mapping data structure 118, includes entries 202, such that for each entry an interrupt source device 204 and an interrupt destination 206 is indicated. For example, in the exemplary interrupt mapping data structure 118a, entry 208 may correspond to interrupt number 0001, where the interrupt source device is I/O device #1 (I/O device 104a) and the interrupt destination is CPU #1 (processor 106a), i.e., interrupt number 0001 generated by device 104a is supposed to be directed to CPU #1, i.e., the processor 106a, for processing. Similarly, entry 210 corresponds to interrupt number 0002, where the interrupt source device is I/O device #2 (device 104b) and the interrupt destination is CPU #3, (processor 106n), and entry 212 corresponds to interrupt number 0003, where the interrupt source device is I/O device #1 (device 104a) and the interrupt destination is CPU #2, (processor 106b). In certain alternative embodiments, the interrupt mapping data structure 118a may be implemented differently from the representation shown in FIG. 2.

The affected interrupts data structure 120 includes an indicator for interrupts pending in local interrupt controller of processor to be disabled 214 and an indicator for interrupts pending from interrupt source devices while retargeting interrupts 216. For example, in the exemplary computing platform 102, the indicator for interrupts pending in local interrupt controller of processor to be disabled 214 may indicate the pending interrupts 200a in the processor 106a, if the processor 106a is to be disabled. While the interrupt migrator 112 retargets interrupts from one processor to another, interrupts may arrive at the computing platform 102. Some of the arriving interrupts may be for the processor that is to be disabled. Such arriving interrupts may be indicated in the indicator for interrupts pending from interrupt source devices while retargeting interrupts 216.

In certain exemplary embodiments, a processor, such as, processor 106a, may need to be disabled in the computing platform 102 illustrated in FIG. 2 without restarting or suspending the operations of the devices 104a . . . 104m.

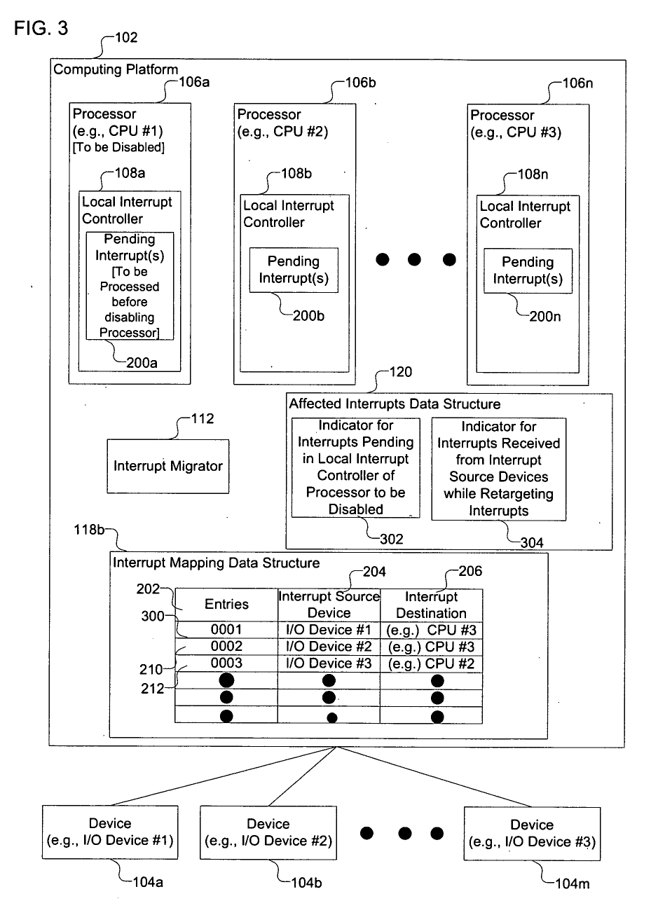

FIG. 3 illustrates how an exemplary processor, such as, the exemplary processor 106a, may be disabled in the computing platform 102.

If the exemplary processor 106a is to be disabled, then in certain embodiments, the interrupt migrator 112 updates the interrupt mapping data structure 118a of FIG. 2 to generate the interrupt mapping data structure 118b of FIG. 3. Since the exemplary processor 106a is to be disabled the interrupt migrator 112 modifies the entry 208 (of FIG. 2) of the interrupt mapping data structure 118a (of FIG. 2) to generate the entry 300 (of FIG. 3) in the modified interrupt management data structure 118b (of FIG. 3). For example, since the processor 106a, i.e., CPU #1, is to be disabled, the interrupt migrator 112 changes the interrupt destination 206 for interrupt 0001 (entry 300) to some other processor, such as, CPU #3, i.e., processor 106c. In an exemplary embodiment, the interrupt migrator 112 proceeds to change the interrupt destination 206 for all entries in the interrupt mapping data structure 118b that indicate the processor to be disabled. In certain embodiments, while an entry in the interrupt mapping data structure 118b is being modified, interrupt processing corresponding to the entry being modified may have to be suspended. As a result, there is a time interval during which an I/O device may assert an interrupt, but this asserted interrupt is not delivered to any processor since the corresponding entry in the interrupt mapping data structure 118b is being modified. In certain embodiments, the interrupt migrator 112 maintains a record of the entries in the interrupt mapping data structure 118b that the interrupt migrator 112 modified.

While the interrupt mapping data structure 118b is being modified, if new interrupts that target the processors to be disabled arrive from the devices 104a . . . 104m, such new interrupts are indicated in the indicator for interrupts received from interrupt source devices while retargeting interrupts 304.

In an exemplary embodiment, after modifications have been completed in the interrupt mapping data structure 118b, the pending interrupts 200a in the processor 106a that to be disabled are processed by the processor 106a that to be disabled. As each pending interrupt 200a is processed, the pending interrupt that has completed processing is removed from the indicator for interrupts pending in local interrupt controller of processor to be disabled 302.

In an exemplary embodiment, after modifications have been completed in the interrupt mapping data structure 118b, the interrupts indicated by the indicator for interrupts received for interrupt source devices while retargeting interrupts 304 are processed by a processor that is not to be disabled, such as, processor 106c. After all indicators indicated in the affected interrupts data structure 120 have been processed, the processor to be disabled is disabled. New interrupts from the devices 104a . . . 104m are processed by determining the processor corresponding to the interrupt destination 206 in the interrupt mapping data structure 118b.

FIG. 3 illustrates an embodiment in which interrupts intended for a processor to be disabled are stored in the affected interrupts data structure 120, while the interrupt mapping data structure 118b is being updated to substitute the processor to be disabled in the interrupt destination 206 fields. Subsequent to updating the interrupt mapping data structure 118b, the pending interrupts in the processor to be disabled are processed and the other interrupts stored in the affected interrupts data structure 120 are processed by at least one processor that is not to be disabled. Subsequently, the processor to be disabled is disabled or removed and new interrupts from the devices 104a . . . 104m are processed by the processors that are not disabled. The devices 104a . . . 104m do not have to be restarted or suspended during any stage of processing.

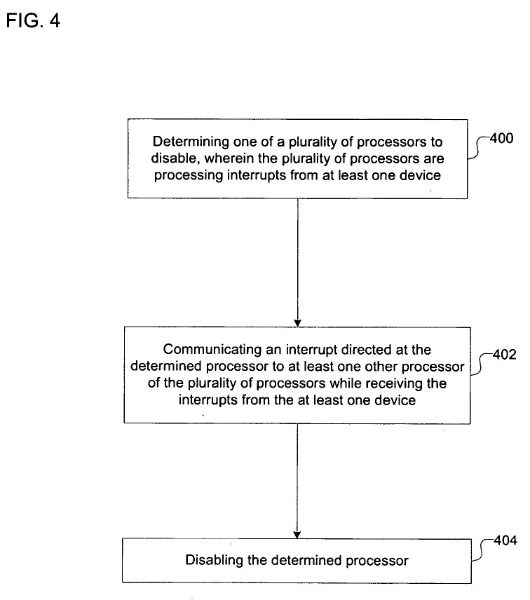

FIG. 4 illustrates operations for disabling a processor, such as, one of the processors 106a . . . 106n, while the computing platform 102 continues to receive interrupts from the devices 104a . . . 104m. In certain embodiments the operations may be implemented in the interrupt migrator 112 of the computing environment 100. In alternative embodiments, the operations may be implemented in the operating system 110 or other elements of the computing environment 100.

Control starts at block 400, where the interrupt migrator 112 determines one of a plurality of processors 106a . . . 106n to disable, wherein the plurality of processors 106a . . . 106n are capable of processing interrupts from at least one device, such as, a device 104a included in the plurality of devices 104a . . . 104m. An indication for determining which processor to disable may be generated by the operating system 110 or by some other application, and the indication may be forwarded to the interrupt migrator 112 to determine the processor to disable. For example, in certain exemplary embodiments the interrupt migrator 112 may determine that processor 106a is to be disabled.

The interrupt migrator 112 communicates (at block 402) an interrupt directed at the determined processor 106a to at least one other processor 106b . . . 106n of the plurality of processors 106a . . . 106n while receiving the interrupts from the at least one device 104a. For example, in certain embodiments if an interrupt is directed at the processor 106a that is to be disabled, the interrupt may be redirected to one other processor, such as, processors 106b . . . 106n. In certain embodiments during the process of communicating, additional interrupts may continue to be received from the at least one device 104a. For example, in certain embodiments the devices 104a . . . 104m are neither stopped or suspended.

Subsequently, the interrupt migrator 112 disables (at block 404) the determined processor. For example, in certain embodiments, the interrupt migrator 112 disables the processor 106a and subsequent interrupts are processed by the remaining processors 106b . . . 106n.

In certain embodiments, disabling the at least one device 104a from which the interrupts are received causes an execution error in the plurality of processors 106a . . . 106b. For example, in certain embodiments if any of the devices 104a . . . 104m are stopped or suspended an execution error may occur in the computing platform 102. Additionally, if a device implements swapping or paging then the device cannot be disabled even temporarily. In certain embodiments, the devices 104a . . . 104m are not disabled while a processor is being disabled.

In certain embodiments, the plurality of processors 106a . . . 106n are CPUs, wherein the at least one device 104a is an input/output device, wherein the communicated interrupt is stored in a plurality of APICs 108a . . . 108n in the central processing units.

FIG. 4 illustrates an embodiment in which, the interrupt migrator 112 disables a processor 106a included in a plurality of processors 106a . . . 106n, without stopping or suspending the devices 104a . . . 104m that continue to generate interrupts.

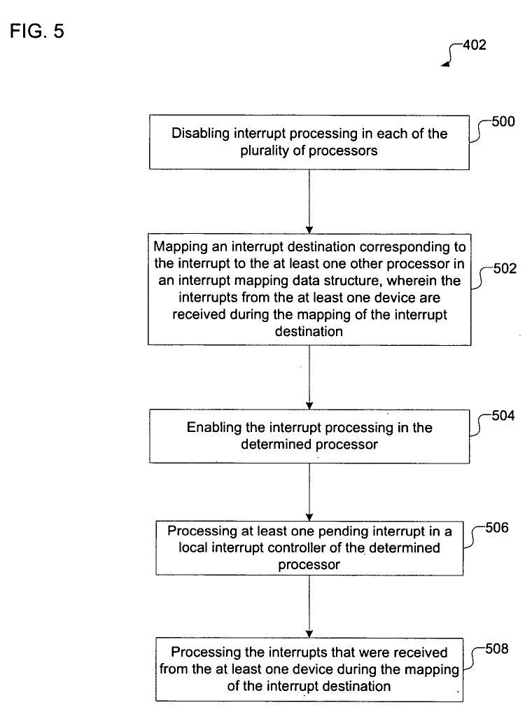

FIG. 5 illustrates operations for communicating an interrupt directed at a processor 106a to another processor 106b . . . 106n. In certain embodiments the operations may be implemented in the interrupt migrator 112 of the computing environment 100. In alternative embodiments, the operations may be implemented in the operating system 110. The operations described in FIG. 5 implement the operations described in block 402 of FIG. 4.

Control starts at block 500, where the interrupt migrator 112 disables interrupt processing in each of the plurality of processors 106a . . . 106n. Disabling the interrupt processing implies that certain interrupts from the devices 104a . . . 104m may time out and may need to be regenerated. However, the devices 104a . . . 104m are not disabled.

The interrupt migrator 112 maps (at block 502) an interrupt destination 206 corresponding to the interrupt to the at least one other processor, such as, processors 106b . . . 106n, in an interrupt mapping data structure (such as, 118, 118b), wherein the interrupts from the at least one device, such as, device 104a, are received during the mapping of the interrupt destination 206. For example, in certain embodiments the interrupt migrator 112 may substitute the entry 300 for the entry 208 in the interrupt mapping data structure 118a (causing a generation of the interrupt mapping data structure 118b) for mapping interrupts targeted at the processor 106a that to be disabled to the processor 106c that is not to be disabled.

After the interrupt mapping data structure 118, 118b has been updated to correctly map the interrupt destinations 206, the pending interrupts in the local interrupt controller of the processor to be disabled should be processed. The interrupt migrator 112 enables (at block 504) the interrupt processing in the determined processor, such as, processor 106a. The interrupt migrator 112 processes (at block 506) at least one pending interrupt in a local interrupt controller, such as, local interrupt controller 108a, of the determined processor, such as, processor 106a. At the conclusion of block 506, the pending interrupts 200a shown in FIGS. 2 and 3 are completely processed by the processor 106a that is to be disabled.

The interrupt migrator 112 processes (at block 508) the interrupts that were received from the at least one device, such as, device 104a, during the mapping of the interrupt destination 206. In certain embodiments, such interrupts received from the at least one device during the mapping of the interrupt destination 206 may have been indicated in the indicator for interrupts received from interrupt source device while retargeting interrupts 304 in the affected interrupts data structure 120.

FIG. 5 illustrates an embodiment in which the interrupt migrator 112 first maps the interrupt destinations 206 in the interrupt mapping data structure 118, 118a, 118b. Then the interrupt migrator 112 process the pending interrupts in the processor to be disabled. Subsequently, the interrupt migrator 112 processes the interrupts received during the mapping of the interrupt destinations 206, such that, the received interrupts are not processed by the processor to be disabled.

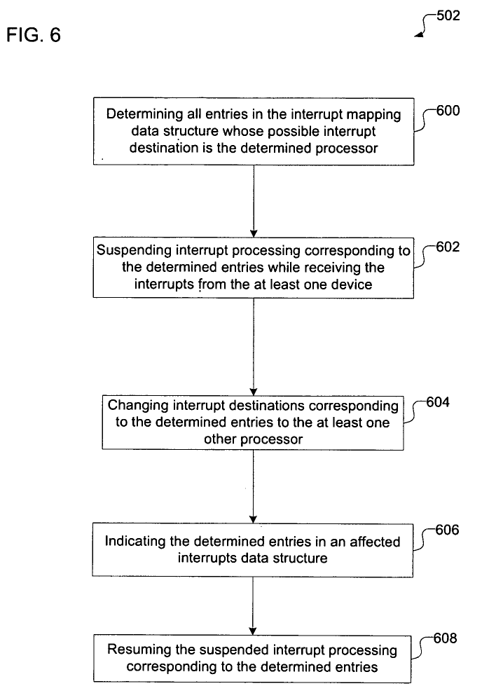

FIG. 6 illustrates operations for mapping interrupt destinations 206 for interrupts. In certain embodiments the operations may be implemented in the interrupt migrator 112 of the computing environment 100. In alternative embodiments, the operations may be implemented in the operating system 110. The operations described in FIG. 6 implement the operations described in block 502 of FIG. 5.

Control starts at block 600, where the interrupt migrator 112 determines all entries in the interrupt mapping data structure 118, 118a, 118b whose possible interrupt destination 206 is the determined processor 104a.

The interrupt migrator 112 suspends (at block 602) interrupt processing corresponding to the determined entries while receiving the interrupts from the at least one device 104a. The interrupt migrator 112 changes (at block 604) interrupt destinations 206 corresponding to the determined entries to the at least one other processor 106b . . . 106n.

The interrupt migrator 112 indicates (at block 606) the determined entries in an affected interrupts data structure 120. Subsequently, the interrupt migrator 112 resumes (at block 608) the suspended interrupt processing corresponding to the determined entries.

FIG. 6 illustrates an embodiment in which the entries 202 of the interrupt mapping data structure are updated to reflect appropriate interrupt destinations 206, in response to a determination that a processor is to be disabled. For example, if processor 106a is to be disabled then interrupt destinations 206 that indicate processor 106a are changed to indicate one of the other processors 106b . . . 106n.

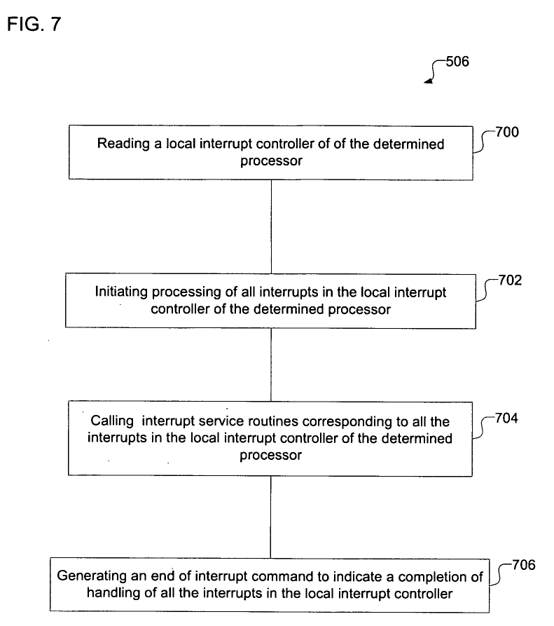

FIG. 7 illustrates operations performed for processing interrupts in a local interrupt controller, such as, local interrupt controller 108a, of a processor, such as, processor 106a. In certain embodiments the operations may be implemented in the computing environment 100. The operations described in FIG. 7 implement the operations described in block 506 of FIG. 5.

Control starts at block 700, where the interrupt migrator 112 reads a local interrupt controller 108a of the determined processor 106a. The determined processor 106a is the processor that is to be disabled.

The interrupt migrator 112 initiates (at block 702) processing of all interrupts in the local interrupt controller 108a of the determined processor 106a. The interrupt migrator 112 calls (at block 704) interrupt service routines 116 corresponding to all the interrupts in the local interrupt controller 108a of the determined processor 106a.

Subsequently, the interrupt migrator 112 generates (at block 706) an end of interrupt command to indicate a completion of handling of all the interrupts in the local interrupt controller 108a.

FIG. 7 illustrates an embodiment in which the pending interrupts 200a in the local interrupt controller 108a of a processor 106a that is to be disabled are processed. For avoiding loss of previously generated interrupts, the processor that is to be disabled should not be disabled without processing the pending interrupts in the local interrupt controller of the processor that is to be disabled.

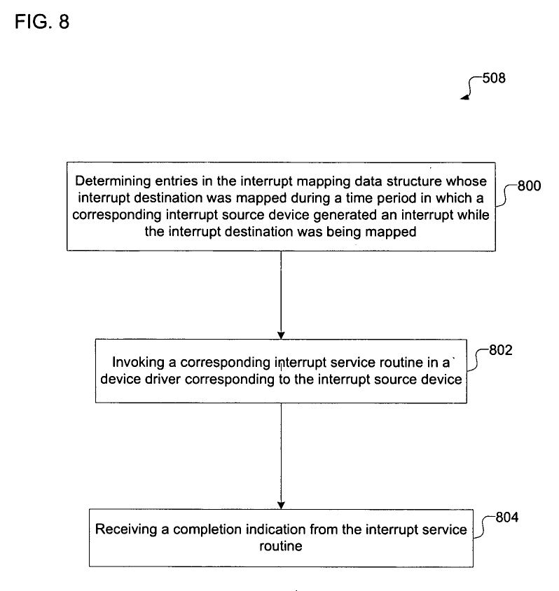

FIG. 8 illustrates operations for processing interrupts that are received from a device, such as, device 104a, during a mapping of the interrupt destinations 206. In certain embodiments the operations may be implemented in the interrupt migrator 112 of the computing environment 100. In alternative embodiments, the operations may be implemented in the operating system 110. The operations described in FIG. 8 implement the operations described in block 508 of FIG. 5.

Control starts at block 800, where the interrupt migrator 112 determines entries in the interrupt mapping data structure 118, 118b whose interrupt destination 206 was mapped during a time period in which a corresponding interrupt source device 204 generated an interrupt while the interrupt destination 206 was being mapped. In certain embodiments, these determined entries may be present in the indicator for interrupts received from interrupt sources devices while retargeting interrupts 216, 304 of the affected interrupts data structure 120.

The interrupt migrator 112 invokes (at block 802) a corresponding interrupt service routine 116 in a device driver 114 corresponding to the interrupt source device 204. The interrupt migrator 112 receives (at block 804) a completion indication from the interrupt service routine 116.

At the completion of the operations described in FIG. 8, the interrupts indicated in the indicator for interrupts received from interrupt source devices while retargeting interrupts 216, 304 have completed processing, and the processor that is to be disabled may be disabled.

Certain embodiments describe a set of operations that are executed in a specified order such that devices 104a . . . 104m do not have to be disabled while a processor 106a . . . 106a is being disabled and corresponding interrupts are being retargeted to a processor that is not be disabled. No modifications are needed to device driver stacks. Additionally, no interrupts are lost and after the disablement of a processor, interrupts are not targeted to the processor that is disabled.

Certain embodiments allow an operating system to dynamically load balance interrupt loads on processors in a multi-processor system. Some embodiments allow hot-plugging CPUs, adjusting number of processors based on demand, and dynamic domain partitioning.

In certain embodiments, when a processor has to be removed while a system is operating, the system ensures that no device in the system will attempt to send an interrupt to a processor that has to be removed. All devices may continue to operate without being notified that a processor was going to be disabled or physically removed.

In certain embodiments, when the single processor is disabled or physically removed, the operating system is able to reprogram the interrupt destination of interrupts asserted by the I/O devices without stopping, restarting, or suspending the operations of the I/O devices.

In certain embodiments, where an operating system may need to change the destination processor information for a storage I/O controller that hosts the paging or swap file. The embodiments do not require the operating system to stop and restart the storage I/O controller that hosts the paging or swap file, since the operating system cannot deal with a situation in which the paging or swap file is unavailable even temporarily. Certain embodiments allow an operating system to be able to reprogram interrupt destination information without stopping and restarting, or suspending and resuming I/O devices.

If an operational I/O device tries to assert an interrupt just at the time the operating system or the interrupt migrator is attempting to change the destination processor information of the I/O device a potential race condition can occur that may cause a system to enter into an unpredictable or unstable state. In certain embodiments such potential race conditions are prevented.

Certain embodiments allow the operating system to safely reprogram the interrupt destinations of I/O devices in an operational system. Certain embodiments do not require the I/O devices to be in a quiescent, i.e., stopped or suspended, state. Certain embodiments do not require I/O devices to be suspended or stopped and does not require any changes or special support in the I/O device driver software. In certain embodiments, the operating system may be able to support capacity on demand, i.e., increase or decrease the number of processors based on the processing load. Additionally, in certain embodiments processors may be dynamically inserted or removed in an operational system. In alternative embodiments, message signaled interrupts may be used instead of using the I/O APIC interrupt controller.

The described techniques may be implemented as a method, apparatus or article of manufacture involving software, firmware, micro-code, hardware and/or any combination thereof. The term “article of manufacture” as used herein refers to program instructions, code and/or logic implemented in circuitry [e.g., an integrated circuit chip, Programmable Gate Array (PGA), Application Specific Integrated Circuit (ASIC), etc.] and/or a computer readable medium (e.g., magnetic storage medium, such as hard disk drive, floppy disk, tape), optical storage (e.g., CD-ROM, DVD-ROM, optical disk, etc.), volatile and non-volatile memory device (e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.). Code in the computer readable medium may be accessed and executed by a machine, such as, a processor. In certain embodiments, the code in which embodiments are made may further be accessible through a transmission medium or from a file server via a network. In such cases, the article of manufacture in which the code is implemented may comprise a transmission medium, such as a network transmission line, wireless transmission media, signals propagating through space, radio waves, infrared signals, etc. Of course, those skilled in the art will recognize that many modifications may be made without departing from the scope of the embodiments, and that the article of manufacture may comprise any information bearing medium known in the art. For example, the article of manufacture comprises a storage medium having stored therein instructions that when executed by a machine results in operations being performed. Furthermore, program logic that includes code may be implemented in hardware, software, firmware or many combination thereof. The described operations of FIGS. 4, 5, 6, 7 may be performed by circuitry, where “circuitry” refers to either hardware or software or a combination thereof. The circuitry for performing the operations of the described embodiments may comprise a hardware device, such as an integrated circuit chip, a PGA, an ASIC, etc. The circuitry may also comprise a processor component, such as an integrated circuit, and code in a computer readable medium, such as memory, wherein the code is executed by the processor to perform the operations of the described embodiments.

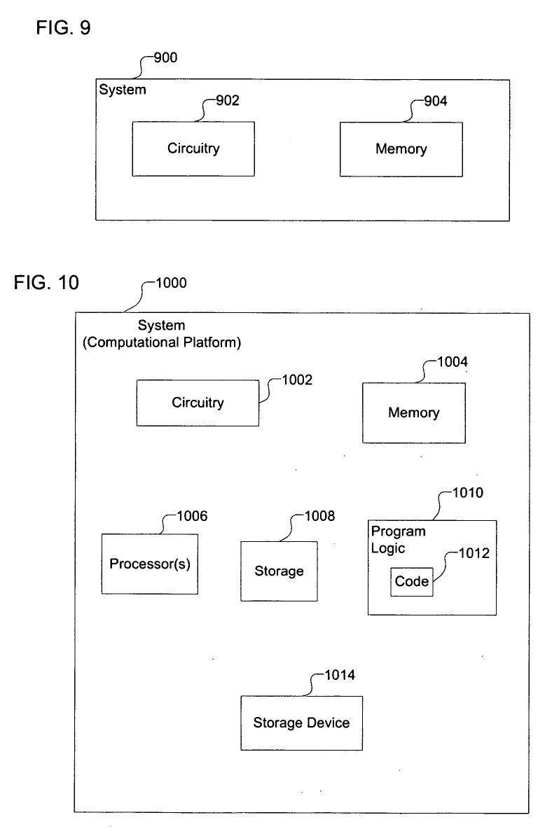

Certain embodiments illustrated in FIG. 9 may implement a first system 900 coupled to at least one device, wherein the first system 900 comprising circuitry 902 coupled to a memory 904, wherein the circuitry 902 is operable to: determine one of the plurality of processors to disable, wherein the plurality of processors are capable of processing interrupts from the at least one device; communicate an interrupt directed at the determined processor to at least one other processor of the plurality of processors while receiving the interrupts from the at least one device; and, disable the determined processor. The circuitry 902 may be capable of performing the functions of the computing platform 102.

FIG. 10 illustrates a block diagram of a second system 1000 in which certain embodiments may be implemented. Certain embodiments may be implemented in systems that do not require all the elements illustrated in the block diagram of the system 1000. The system 1000 may include circuitry 1002 coupled to a memory 1004, wherein the described operations of FIGS. 4-8 may be implemented by the circuitry 1002. In certain embodiments, the system 1000 may include one or more processors 1006 and a storage 1008, wherein the storage 1008 may be associated with program logic 1010 including code 1012, that may be loaded into the memory 1004 and executed by the processor 1006. In certain embodiments the program logic 1010 including code 1012 is implemented in the storage 1008. In certain other embodiments, the operations performed by program logic 1010 including code 1012 may be implemented in the circuitry 1002. Additionally, the system 1000 may also include a storage device 1014.

In certain embodiments, the storage device 1014 may be absent in the system 1000. Instead of the storage device 1014, in alternative embodiments the system 1000 may include another device, such as, a video or graphics device that renders information to display on a monitor coupled to the system 1000, where the system 1000 may comprise a desktop, workstation, server, mainframe, laptop, handheld computer, etc. An operating system may be capable of execution by the system, and the video controller may render graphics output via interactions with the operating system. Alternatively, some embodiments may be also be implemented in a computer system that does not include a video or graphics controller but includes a switch, router, etc.

At least certain of the operations of FIGS. 4-8 can be performed in parallel as well as sequentially. In alternative embodiments, certain of the operations may be performed in a different order, modified or removed. Furthermore, many of the software and hardware components have been described in separate modules for purposes of illustration. Such components may be integrated into a fewer number of components or divided into a larger number of components. Additionally, certain operations described as performed by a specific component may be performed by other components.

The data structures and components shown or referred to in FIGS. 1-10 are described as having specific types of information. In alternative embodiments, the data structures and components may be structured differently and have fewer, more or different fields or different functions than those shown or referred to in the figures. Therefore, the foregoing description of the embodiments has been presented for the purposes of illustration and description. It is not intended to be exhaustive or to limit the embodiments to the precise form disclosed. Many modifications and variations are possible in light of the above teaching.

What is claimed I:

1. A method, comprising:
determining one of a plurality of processors to disable, wherein the plurality of processors are processing interrupts from at least one device;
communicating an interrupt directed at the determined processor to at least one other processor of the plurality of processors while receiving the interrupts from the at least one device; and
disabling the determined processor.

2. The method of claim 1, wherein the communicating of the interrupt while receiving the interrupts from the at least one device further comprises:
disabling interrupt processing in each of the plurality of processors;
mapping an interrupt destination corresponding to the interrupt to the at least one other processor in an interrupt mapping data structure, wherein the interrupts from the at least one device are received during the mapping of the interrupt destination;
enabling the interrupt processing in the determined processor;
processing at least one pending interrupt in a local interrupt controller of the determined processor; and
processing the interrupts that were received from the at least one device during the mapping of the interrupt destination.

3. The method of claim 2, wherein the mapping of the interrupt destination to the at least one other processor further comprises:
determining all entries in the interrupt mapping data structure whose possible interrupt destination is the determined processor;
suspending interrupt processing corresponding to the determined entries while receiving the interrupts from the at least one device;
changing interrupt destinations corresponding to the determined entries to the at least one other processor;
indicating the determined entries in an affected interrupts data structure; and
resuming the interrupt processing corresponding to the determined entries.

4. The method of claim 2, wherein the processing of the at least one pending interrupt in the local interrupt controller of the determined processor further comprises:
reading a local interrupt controller of the determined processor;
initiating processing of all interrupts in the local interrupt controller of the determined processor;
calling interrupt service routines corresponding to all the interrupts in the local interrupt controller of the determined processor; and
generating an end of interrupt command to indicate a completion of handling of all the interrupts in the local interrupt controller.

5. The method of claim 2, wherein the processing of the interrupts that were received from the at least one device during the mapping of the interrupt destination further comprises:
determining entries in the interrupt mapping data structure whose interrupt destination was mapped during a time period in which a corresponding interrupt source device generated an interrupt while the interrupt destination was being mapped;
invoking a corresponding interrupt service routine in a device driver corresponding to the interrupt source device; and
receiving a completion indication from the interrupt service routine.

6. The method of claim 1, wherein the disabling of the at least one device from which the interrupts are received causes an execution error in the plurality of processors, and wherein the at least one device remains operational during the determining, the communicating, and the disabling.

7. The method of claim 1, wherein the plurality of processors are central processing units, wherein the at least one device is an input/output device, wherein the communicated interrupt is stored in a plurality of advanced programmable interrupt controllers in the central processing units.

8. A system coupled to at least one device, the system comprising:
a plurality of processors;
memory coupled to the plurality of processors; and
circuitry coupled to the memory, wherein the circuitry is operable to:
(i) determine one of the plurality of processors to disable, wherein the plurality of processors are capable of processing interrupts from the at least one device;
(ii) communicate an interrupt directed at the determined processor to at least one other processor of the plurality of processors while receiving the interrupts from the at least one device; and
(iii) disable the determined processor.

9. The system of claim 8, wherein the circuitry is capable to communicate the interrupt while receiving the interrupts from the at least one device by being further operable to:
disable interrupt processing in each of the plurality of processors;
map an interrupt destination corresponding to the interrupt to the at least one other processor in an interrupt mapping data structure, wherein the interrupts from the at least one device are received during the mapping of the interrupt destination;
enable the interrupt processing in the determined processor;
process at least one pending interrupt in a local interrupt controller of the determined processor; and
process the interrupts that were received from the at least one device during the mapping of the interrupt destination.

10. The system of claim 9, wherein the circuitry is capable to map the interrupt destination to the at least one other processor by being further operable to:
determine all entries in the interrupt mapping data structure whose possible interrupt destination is the determined processor;
suspend interrupt processing corresponding to the determined entries while receiving the interrupts from the at least one device;
change interrupt destinations corresponding to the determined entries to the at least one other processor;
indicate the determined entries in an affected interrupts data structure; and
resume the interrupt processing corresponding to the determined entries.

11. The system of claim 9, wherein the circuitry is capable to process the at least one pending interrupt in the local interrupt controller of the determined processor by being further operable to:
read a local interrupt controller of the determined processor;
initiate processing of all interrupts in the local interrupt controller of the determined processor;
call interrupt service routines corresponding to all the interrupts in the local interrupt controller of the determined processor; and
generate an end of interrupt command to indicate a completion of handling of all the interrupts in the local interrupt controller.

12. The system of claim 9, wherein the circuitry is capable to process the interrupts that were received from the at least one device during the mapping of the interrupt destination by being further operable to:
determine entries in the interrupt mapping data structure whose interrupt destination was mapped during a time period in which a corresponding interrupt source device generated an interrupt while the interrupt destination was being mapped;
invoke a corresponding interrupt service routine in a device driver corresponding to the interrupt source device; and
receive a completion indication from the interrupt service routine.

13. The system of claim 8, wherein a disablement of the at least one device from which the interrupts are received is capable of causing an execution error in the plurality of processors, and wherein the at least one device is capable of remaining operational while the circuitry disables the determined processor.

14. The system of claim 8, wherein the plurality of processors are central processing units, wherein the at least one device is an input/output device, the system further comprising:
a plurality of advanced programmable interrupt controllers implemented in the central processing units, wherein the communicated interrupt is stored in the plurality of advanced programmable interrupt controllers.

15. A system, comprising:
a plurality of processors;
memory coupled to the plurality of processors;
at least one storage device communicatively coupled to the memory;
circuitry coupled to the memory, wherein the circuitry is operable to:
(i) determine one of the plurality of processors to disable, wherein the plurality of processors are capable of processing interrupts from the at least one storage device;
(ii) communicate an interrupt directed at the determined processor to at least one other processor of the plurality of processors while receiving the interrupts from the at least one storage device; and
(iii) disable the determined processor.

16. The system of claim 15, wherein the circuitry is capable to communicate the interrupt while receiving the interrupts from the at least one device by being further operable to:
disable interrupt processing in each of the plurality of processors;
map an interrupt destination corresponding to the interrupt to the at least one other processor in an interrupt mapping data structure, wherein the interrupts from the at least one device are received during the mapping of the interrupt destination;
enable the interrupt processing in the determined processor;
process at least one pending interrupt in a local interrupt controller of the determined processor; and
process the interrupts that were received from the at least one device during the mapping of the interrupt destination.

17. The system of claim 15, wherein a disablement of the at least one device from which the interrupts are received is capable of causing an execution error in the plurality of processors, and wherein the at least one device is capable of remaining operational while the circuitry disables the determined processor.

18. The system of claim 15, wherein the plurality of processors are central processing units, wherein the at least one device is an input/output device, the system further comprising:
a plurality of advanced programmable interrupt controllers implemented in the central processing units, wherein the communicated interrupt is stored in the plurality of advanced programmable interrupt controllers.

19. An article of manufacture, wherein the article of manufacture comprises a machine accessible medium having stored therein instructions capable of interfacing a plurality of processors to at least one device, and wherein the instructions when accessed causes a machine to:
determine one of the plurality of processors to disable, wherein the plurality of processors are capable of processing interrupts from the at least one device;
communicate an interrupt directed at the determined processor to at least one other processor of the plurality of processors while receiving the interrupts from the at least one device; and
disable the determined processor.

20. The article of manufacture of claim 19, wherein the instructions are capable to communicate the interrupt while receiving the interrupts from the at least one device by further causing the machine to:
disable interrupt processing in each of the plurality of processors;
map an interrupt destination corresponding to the interrupt to the at least one other processor in an interrupt mapping data structure, wherein the interrupts from the at least one device are received during the mapping of the interrupt destination;
enable the interrupt processing in the determined processor;
process at least one pending interrupt in a local interrupt controller of the determined processor; and
process the interrupts that were received from the at least one device during the mapping of the interrupt destination.

21. The article of manufacture of claim 20, wherein the instructions are capable to map the interrupt destination to the at least one other processor by further causing the machine to:
determine all entries in the interrupt mapping data structure whose possible interrupt destination is the determined processor;
suspend interrupt processing corresponding to the determined entries while receiving the interrupts from the at least one device;
change interrupt destinations corresponding to the determined entries to the at least one other processor;
indicate the determined entries in an affected interrupts data structure; and
resume the interrupt processing corresponding to the determined entries.

22. The article of manufacture of claim 20, wherein the instructions are capable to process the at least one pending interrupt in the local interrupt controller of the determined processor by further causing the machine to:
read a local interrupt controller of the determined processor;
initiate processing of all interrupts in the local interrupt controller of the determined processor;
call interrupt service routines corresponding to all the interrupts in the local interrupt controller of the determined processor; and
generate an end of interrupt command to indicate a completion of handling of all the interrupts in the local interrupt controller.

23. The article of manufacture of claim 20, wherein the instructions are capable to process the interrupts that were received from the at least one device during the mapping of the interrupt destination by further causing the machine to:
determine entries in the interrupt mapping data structure whose interrupt destination was mapped during a time period in which a corresponding interrupt source device generated an interrupt while the interrupt destination was being mapped;
invoke a corresponding interrupt service routine in a device driver corresponding to the interrupt source device; and
receive a completion indication from the interrupt service routine.

24. The article of manufacture of claim 19, wherein a disablement of the at least one device from which the interrupts are received causes an execution error in the plurality of processors, and wherein the at least one device remains operational while the determined processor is being disabled.

25. The article of manufacture of claim 19, wherein the plurality of processors are central processing units, wherein the at least one device is an input/output device, wherein a plurality of advanced programmable interrupt controllers are implemented in the central processing unit, and wherein the instructions further cause the machine to:
store the communicated interrupt in the plurality of advanced programmable interrupt controllers.
